(19) United States
(12) Patent Application Publication
(10) Pub. No.: US 2024/0091789 A1
(43) Pub. Date: Mar. 21, 2024

(54) APPARATUS AND METHOD FOR SEPARATING MAGNETIC PARTICLES FROM LIQUIDS AND SLURRIES

(71) Applicant: ROMAR INTERNATIONAL LIMITED, Ellon Aberdeenshire (GB)

(72) Inventors: Malcolm Mackenzie, Ellon Aberdeenshire (GB); Martin McKenzie, Ellon Aberdeenshire (GB)

(21) Appl. No.: 17/774,011

(22) PCT Filed: Oct. 30, 2020
(86) PCT No.: PCT/GB2020/052754

§ 371 Date: May 3, 2022

(30) Foreign Application Priority Data
Nov. 4, 2019 (GB) 1916028.2

(51) Int. Cl. B03C 1/28; B03C 1/033

(52) U.S. Cl. CPC B03C 1/286; B03C 1/0332; B03C 1/288; B03C 2201/18; E21B 21/065

(57) ABSTRACT

The invention provides an apparatus for separating ferrous particles from a liquid or slurry, and a method of use. The apparatus comprises an elongate housing, a magnet assembly located within the elongate housing and a drive means. The drive means is operable to translate reciprocating motion to the magnet assembly, to move it back and forth within the elongate housing. The elongate housing comprises one or more formations along its length.

The present invention relates to an apparatus for separating and/or removing ferrous (magnetic) particles from contaminated liquids and slurries, and a method of use of such apparatus. In particular, the invention has particular (although not exclusive) application to the separation of ferrous particles from a liquid or slurry which has been used in an oil or gas operation such as a hydrocarbon production or transportation operation and which has been subject to a cutting, milling, grinding or drilling process, or similar. The invention in one of its aspects relates to a dewatering apparatus for and method of extracting liquid from a slurry containing magnetic particles.

### BACKGROUND TO THE INVENTION

In the oil and gas exploration and production industry, it is common to cut, mill, grind or drill through metal components. During such processes, fluid (commonly known as cutting, drilling or milling fluid) is used to lubricate and cool the cutting surfaces. This fluid is also often used to transfer the metal material removed by the cutting, milling, grinding or drilling process (sometimes referred to as cuttings) away from the cutting area to avoid clogging or damage to the tool or tools in use. Therefore, it is common practice to circulate, process and re-circulate this fluid during such operations. The processing step typically aims to remove the bulk of the metal material (cuttings) from the fluid before it is reused.

It is known to treat such fluid using magnetic fields to separate the bulk of the metal material from the fluid before it is re-used. Such operations are typically large scale (i.e. they handle large volumes of fluid at substantial flow rates) and, ultimately, are not able to definitively remove all metal material from the fluid. In addition, these operations may require some form of manual intervention to clean the devices which are used for the separation. Another factor that must be considered is the size, shape and spatial requirements of the separation devices and how this may impact the existing process and/or flow system.

Various other industries also require the removal of metal material from either a certain location or from a liquid or slurry. Such industries, for example, include (but are not limited to) the food and drink, manufacturing, agricultural, pharmaceutical, environmental and power generation industries.

### SUMMARY OF THE INVENTION

There is generally a need for a method and apparatus which addresses the need to provide a flexible magnetic separation system, which can be adapted for use in various applications having specific spatial constraints and access requirements.

It is amongst the aims and objects of the invention to provide a method and/or apparatus for removing ferrous particles (magnetically attractable particles herein also interchangeably referred to as magnetic particles) from liquids and/or slurries and which is an alternative to the methods and/or apparatus provided by the prior art.

It is amongst the aims and objects of the invention to provide a method and/or apparatus for removing magnetic particles from liquids and/or slurries and which obviates or mitigates one or more drawbacks or disadvantages of the prior art.

It is amongst the aims and objects of the invention to provide a method and/or apparatus for transporting magnetic particles which obviates or mitigates one or more drawbacks or disadvantages of the prior art.

Other aims and objects of the invention include providing an improved apparatus and method of use for removing magnetic particles from liquids and/or slurries and/or for transporting magnetic particles.

An object of the invention is to provide a flexible apparatus and method of use suitable for use with and/or retrofitting existing processing or flow systems, for removing magnetic particles from liquids and/or slurries and/or for transporting magnetic particles.

An object of the invention is to provide a dewatering apparatus for and method of extracting liquid from a slurry containing magnetic particles.

According to a first aspect of the invention, there is provided an apparatus for removing ferrous particles from a liquid or slurry, the apparatus comprising:
an elongate housing;
a magnet assembly located within the elongate housing;
a drive means operable to effect reciprocating motion to the magnet assembly such that the magnet assembly is reciprocated within the elongate housing; and a plurality of formations along the length of the elongate housing, the formations configured to prevent the passage of at least some ferrous particles in one direction along the length of the elongate housing of the apparatus during reciprocation of the magnet assembly.

Part of the apparatus may be configured to extend into a volume or a body of liquid or slurry. In particular, at least one section of the elongate housing of the apparatus may be configured to extend into a volume or a body of liquid or slurry. The liquid or slurry may be a flowing liquid or slurry, which may be flowing in a flow system or a flow network which may include pipelines or flow channels, and/or it may be a stationary liquid or slurry which may similarly be contained within pipelines or flow channels and/or which may be held within a container or a vessel.

The apparatus may be operable to attract, collect and retain magnetic particles. The apparatus may also be operable to discharge magnetic particles therefrom.

Preferably, the magnet assembly located within the elongate housing is operable to attract ferrous (magnetic) particles which may be contained within the liquid or slurry and collect the particles on an outer surface or surfaces of the elongate housing. The magnet assembly may be operable to move the collected magnetic particles along and over the outer surface or surfaces of the elongate housing and discharge the collected magnetic particles from the outer surface or surfaces of the elongate housing at a location displaced from the main volume or body of liquid or slurry.

The apparatus may comprise a first end and a second end. The apparatus is preferably operable to move the collected magnetic particles along and over the outer surface or surfaces of the elongate housing, from the first end of the apparatus towards the second end of the apparatus by operation of the magnet assembly.

At least the first end and/or a first end region of the apparatus may be operable to attract and retain magnetic particles to the outer surface or surfaces of the elongate housing. The first end of the apparatus may be a first, enclosed end and/or end region of the elongate housing which may be configured to extend into and/or be submerged in a volume or a body of liquid or slurry. The magnet assembly located within the elongate housing may be operable to attract magnetic particles to the outer surface or surfaces of the elongate housing at least at the first end of the apparatus.

The second end and/or a second end region of the apparatus may be operable to discharge magnetic particles from the outer surface or surfaces of the elongate housing.

The second end of the apparatus may be a second end and/or end region of the elongate housing which may displaced from the main volume or body of liquid or slurry into which at least the first end of the apparatus extends. The magnet assembly located within the elongate housing may be operable to discharge magnetic particles from the outer surface or surfaces of the elongate housing at the second end of the apparatus.

The elongate housing may be formed from any material that allows a magnetic field or fields to pass through it, in particular such that the magnetic field or fields generated by the magnet assembly located within the elongate housing may pass through it to attract and collect magnetic particles to the outer surface or surfaces of the housing.

The formations on the elongate housing may be formed integrally with the housing, or may be separately attached thereto in a fixed or removable manner, for example by welding or screwing. The position of the formations may be moveable on the housing.

The elongate housing and/or the formations may be formed from a metal or a plastic, or a combination of the two. For example, if the composition of the liquid or slurry into which the elongate housing is intended to extend is expected to damage or degrade a plastic material, it may be suitable to provide a metal elongate housing. However, the formations along the length of the housing may be provided as formations formed from a plastic material, which would facilitate cheap replacement of the formations and the flexibility to easily form the formations in various shapes and sizes. The choice of materials may also be influenced by the required maximum weight of the apparatus, if this is an operating constraint.

The elongate housing may be substantially tubular.

The plurality of formations may each comprise a ramped surface and may each comprise a shoulder. A shoulder may for example be in the form of a surface which projects outwardly from an outer surface of the housing in a direction transverse to a longitudinal axis of the housing and which may be oriented to face towards the second end of the apparatus. The formations may extend radially, or substantially radially, from a longitudinal axis of the elongate housing. The formations may be perpendicularly or substantially perpendicularly oriented to the axis of the elongate housing. The formations may comprise annular surfaces which project outwardly from the outer surface of the housing. The formations may be oriented to face towards the second end of the apparatus.

The plurality of formations may be configured to prevent the passage of at least some of the collected magnetic particles in a direction towards the source from which the magnetic particles originated (i.e. towards the liquid or slurry). Preferably, the plurality of formations are be configured to prevent the passage of at least some of the collected magnetic particles in a direction towards the first end of the elongate housing of the apparatus, as the particles are moved from the first end of the apparatus towards the second end of the apparatus. The plurality of formations are preferably operable to support and/or retain or to aid with support and/or retention of magnetic particles at a particular location on the outer surface of the elongate housing.

The formations may be upstanding from a main surface of the elongate housing, or may be formed into or recessed into the main surface of the elongate housing.

The elongate housing may be formed as one, rigid part in the size and shape required by a particular application. The housing may be formed in various shapes which may comprise curved sections, straight sections, elbows and/or bends. For example, the elongate housing may be (but is not limited to being) straight (one-dimensional orientation), L-shaped, S-shaped (two-dimensional orientation) or formed as a spiral or coil (three-dimensional orientation). The elongate housing may be three-dimensionally oriented comprising curved sections, straight sections, elbows and/or bends in the direction of any of the x, y or z axes.

In an alternative embodiment of the invention, the elongate housing may be formed from multiple sections that can be connected to form an elongate housing in any desired size or shape. Each section may be identical. Each section may comprise a housing portion and a formation portion such that, when assembled together, the sections form an elongate housing comprising one or more formations, wherein the formation comprise the formation portions of the sections. After connecting the multiple sections together, the size and shape of the elongate housing may be fixed, for example by curing, welding, clamping or clipping the sections together.

Alternatively, multiple sections may be connected to form an articulated elongate housing wherein one or more section or sections is or are permitted to move with respect to its adjacent neighbouring sections. An articulated elongate housing may be manipulated into a variety of shapes, once assembled and re-shaped when desired or for particular applications. The length of an elongate housing of this type may be extended by the addition of one or more sections. This type of housing has particular advantages for use in applications in which the apparatus is required to pass through a narrow opening, travel around corners or work around equipment.

The magnet assembly may comprise one magnetic unit or a plurality of magnetic units.

Each magnetic unit may comprise at least one magnet. The at least one magnet may be a permanent magnet and/or an electromagnet and which generates a magnetic field. Each magnetic unit may further comprise one or more pole pieces, operable to direct the magnetic field of the magnets. Each magnetic unit may further comprise one or more wear discs to reduce wear on the magnets and/or the pole pieces.

The plurality of magnetic units may be linked together to form a chain of magnetic units. The plurality of magnetic units may each comprise a linkage means. The linkage means of one magnetic unit may be configured to connect to the linkage means of another magnetic unit. Preferably, the linkage means of one or more of the magnetic units of the plurality of magnetic units enables the magnetic units to be connected to one another to form a chain. The at least one magnet of one or more of the plurality of magnetic units may comprise an aperture extending through it, said aperture may be positioned axially, to enable part of the linkage means to be attached to the magnetic unit. Preferably, the plurality of magnetic units are linked together in such a way that each magnetic unit is advantageously permitted to move with respect to its adjacent magnetic unit. Such flexibility is advantageous where the magnetic assembly is required to operate (i.e. move with reciprocating motion) within an elongate housing comprising curved sections, bends and/or elbows.

The plurality of magnetic units of the magnet assembly may be arranged such that the at least one magnet of adjacent magnetic units have the same poles (i.e. repelling poles) positioned adjacent to one another (i.e. facing one another). This configuration is advantageous because the magnetic fields which are generated by the magnetic units are forced to spread a distance further out from the apparatus. This feature is typically desirable to achieve better magnetic separation. Alternatively, the at least one magnet of adjacent magnetic units may be arranged to have opposite poles (i.e. attracting poles) positioned adjacent to one another (i.e. facing one another).

The magnet assembly may further comprise one or more sections which are devoid of magnetic units, and which are not configured to generate magnetic fields. In particular, where the apparatus is configured to discharge magnetic particles therefrom, the magnet assembly may comprise a section which is free from magnetic units and which does not generate a magnetic field. This section of the magnet assembly is preferably located at the second end or end region of the apparatus.

The apparatus may further comprise one or more centralisers which may be configured to be mounted to the magnet assembly and which may function to retain the magnet assembly in a central positioned within the housing during reciprocal motion. The centralisers may be powered and assist with and/or impart motion to the magnet assembly.

The apparatus may further comprise a collection container or vessel. This may be located substantially underneath the second end and/or end region of the apparatus. When magnetic particles are discharged at the second end and/or end region of the apparatus, they may be received by the collection container or vessel. The particles may fall under the influence of gravity into the collection container or vessel.

The drive means may be a motor, such as an electric motor. Where the direct result of the drive means is rotational motion, the drive means may be used in conjunction with a rotational cam in order to effect linear, reciprocating motion. Alternatively, the drive means may be a piston-cylinder arrangement, such as a pneumatic or hydraulic piston-cylinder arrangement. The drive means may be a RAM type pneumatic or hydraulic piston-cylinder arrangement.

The drive means may be operated manually. Alternatively, or in addition, the drive means may be controlled remotely and/or by a control unit and/or automatically. Operation of the drive means may be automated. Operation of the drive means and may be controlled and/or operated automatically in response to operating parameters and/or characteristics relating to the system.

According to a second aspect of the invention, there is provided a method of removing ferrous particles from a volume or a body of liquid and/or slurry, the method comprising: providing an apparatus comprising:
an elongate housing comprising a plurality of formations along its length;
a magnet assembly located within the elongate housing; and
a drive means operable to effect reciprocating motion to the magnet assembly
within the elongate housing;
positioning at least a section of the elongate housing of the apparatus to extend into the volume or body the liquid and/or slurry;
attracting ferrous particles contained within the liquid or slurry to an outer surface or surfaces of the elongate housing under influence of the magnet assembly;
operating the drive means to reciprocate the magnet assembly within the elongate housing; and
moving the magnetic particles along the outer surface or surfaces of the elongate housing under influence of the reciprocating magnet assembly.

The apparatus may comprise a first end and/or end region operable to attract and retain magnetic particles and a second end and/or end region operable to discharge magnetic particles. The first end of the apparatus may be a first, enclosed end and/or end region of the elongate housing and the second end of the apparatus may be a second end and/or end region of the elongate housing.

The method may comprise submerging the first end of the elongate housing in the volume or body of liquid or slurry.

The magnet assembly located within the elongate housing may have a first fully extended condition, in which it may be moved towards the first end of the apparatus by a maximum distance, and a second, fully retracted condition, in which it may be moved towards the second end of the apparatus by a maximum distance.

The method may comprise operating the drive means to move the magnet assembly between its first, fully extended, condition and its second, fully retracted, condition, and vice versa.

The magnet assembly located within the elongate housing may be operable to attract magnetic particles to the outer surface or surfaces of the elongate housing at the first end of the apparatus. The method may comprise attracting magnetic particles contained within the volume or body of liquid and/or slurry in which the first end of the apparatus is located to the outer surface of the elongate housing at the first end of the apparatus when the magnet assembly is in its first, fully extended condition.

The method may comprise operating the drive means to reciprocate the magnet assembly back and forth between the first, fully extended, condition and the second, fully retracted, condition. Reciprocating motion of this kind may cause magnetic particles attracted to the first end of the apparatus to move along the length of the outer surface or surfaces of the elongate housing towards the second end of the apparatus.

The method may comprise supporting and/or retaining, and/or helping to support and/or retain, collected magnetic particles on the outer surface of the elongate housing as they are moved along the housing. The method may comprise using one or more of the formations along the length of the elongate housing to support and/or retain, and/or help to support and/or retain, collected magnetic particles on the outer surface of the elongate housing as they are moved along the housing towards the second end.

The formations may function to allow the particles to move in one direction along the housing only: towards the second end of the apparatus. The method may comprise impeding backward motion of the collected magnetic particles as they are moved along the housing, which may be done by the plurality of formations. In particular, the method may comprise using one or more of the formations along the length of the elongate housing to impede or prevent motion of the magnetic particles towards the first end of the apparatus.

The method may comprise exposing the collected magnetic particles to a region of low, minimal or no magnetic field strength. The magnetic particles may be exposed to a region of low, minimal or no magnetic field strength when they are at or close to the second end and/or end region of the apparatus. The method may comprise releasing and discharging magnetic particles from the apparatus when they are no longer attracted to the apparatus by a magnetic field (i.e. which may be when they are exposed to a region of low, minimal or no magnetic field strength at or near the second end and/or end region of the apparatus).

The method may comprise locating a collection container or vessel beneath the apparatus to receive magnetic particles that are discharged from the apparatus. The method may comprise locating a collection container or vessel beneath the second end of the apparatus and may comprise collecting magnetic particles that are discharged from the apparatus.

The method may comprise continuously operating the apparatus to continuously remove magnetic particles from a liquid and/or slurry.

Embodiments of the second aspect of the invention may include one or more features of the first aspect of the invention or its embodiments, or vice versa.

According to a third aspect of the invention, there is provided an installation on an oil and gas drilling facility, the installation comprising:
a shale shaker configured to receive fluids from a drilling operation, the shale shaker comprising a header box; and
a magnetic separator apparatus comprising;
   an elongate housing comprising a first end, and second end and a plurality of formations along its length;
   a magnet assembly located within the elongate housing; and
   a drive means operable to effect reciprocating motion to the magnet assembly such that magnet assembly reciprocates within the elongate housing;
wherein the first end of the elongate housing of the magnetic separator apparatus extends into the shale shaker header box and is at least partially immersed in the fluids therein when in use.

The fluids from the drilling operation may contain ferrous (magnetic) particles.

The magnet assembly of the magnetic separator apparatus may be configured to attract magnetic particles from within the fluid to an outer surface of the first end of the elongate housing. Operation of the drive means may be configured to move magnetic particles along the length of the elongate housing of the apparatus, from the first end to the second end, and the apparatus may be configured to discharge magnetic particles at the second end of the elongate housing.

The second end of the elongate housing may be displaced from the header box, and may be configured to discharge the magnetic particles into a collection vessel or container.

Embodiments of the third aspect of the invention may include one or more features of the first or second aspects of the invention or their embodiments, or vice versa.

### BRIEF DESCRIPTION OF THE DRAWINGS

There will now be described, by way of example only, various embodiments of the invention with reference to the drawings, of which:

FIGS. 1A, 1B and 1C are schematic side, sectional, and transparent views of a magnetic separating apparatus according to a first embodiment of the invention;

FIG. 1D is an enlarged detailed view of the apparatus of FIGS. 1A to 10, showing part of the internal magnet assembly;

FIGS. 2A to 2D are schematic views of the apparatus of FIGS. 1A to 1D in operation;

FIG. 3 is a schematic side view of an apparatus according to an alternative embodiment of the invention;

FIG. 4 is a schematic side view of an apparatus according to an alternative embodiment of the invention;

FIG. 5 is a schematic perspective view of an apparatus according to an alternative embodiment of the invention;

FIG. 6 is a schematic representation of sections of an apparatus according to an alternative embodiment of the invention;

FIG. 7 is a schematic perspective view of an apparatus according to an embodiment of the invention in an example application.

### DETAILED DESCRIPTION OF PREFERRED EMBODIMENTS

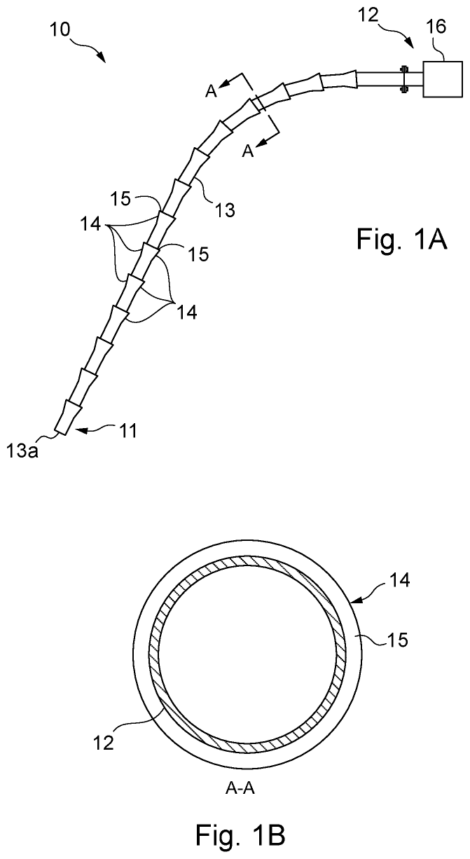

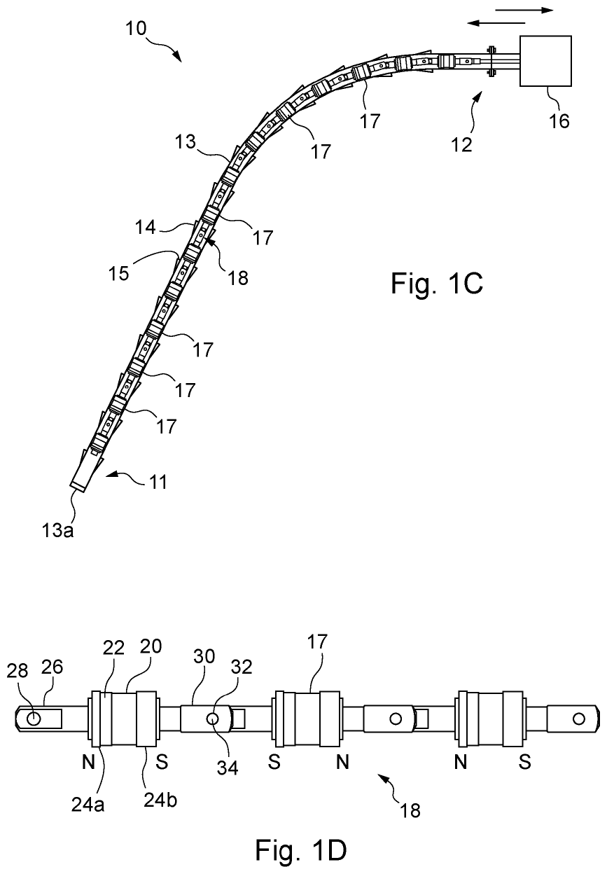

Referring firstly to FIG. 1A, there is shown, generally at 10, an outer view of a magnetic separator apparatus. The apparatus has a first end, shown generally at 11, a second end, shown generally at 12 and comprises an outer housing 13 containing an internal magnet assembly (not shown in this Figure). The outer housing 13 is generally L-shaped, with an inclined section. However, it will be appreciated that alternative embodiments of the invention, different shapes of outer housings may be provided, such as S-shaped or generally straight outer housing, for example. In operation, the first end 11 of the apparatus is operable to attract and retain magnetic particles on the apparatus. The magnetic particles are moved along the length of the outer housing 13, in a manner that will become clear throughout the following description, towards the second end 12 of the apparatus. At its second end, the apparatus is operable to discharge collected magnetic particles. At the first end 11 the outer housing 13 is enclosed at its base 13a.

The outer housing 13 is substantially tubular in form and comprises a series of formations 14 along its length. The formations 14 (which can be more clearly seen in the enlarged sectional view of FIG. 1B) comprise conical portions which expand like ramps from the outer surface of the outer housing 13 and which form surfaces 15 projecting outwardly from the outer surface, like shoulders along its length. The surfaces 15 are substantially perpendicular to the axis of the housing 13 and face towards the second end 12 of the apparatus. Although substantially flat (planar) surfaces 15 are shown, these could be curved or comprise additional parts such as a lip around their edges.

In the embodiment shown, the outer housing of the apparatus is formed from a pipe which has been bent into the L-shape shown. The formations are conical pipe reducer portions having a first inner diameter at one end and a second, larger inner diameter at the other end. The first inner diameter is selected to match or be in close tolerance with the outer diameter of the pipe (i.e. the housing). The pipe reducers are slotted on to the pipe and welded into place on the pipe at even intervals, or where desired, to make the formations 14. The welded section between the outer surface of the pipe and the second, larger diameter ends of the reducers form the surfaces 15.

In operation, the surfaces 15 help to retain collected magnetic particles at specific locations on the apparatus 10 as they are moved along the length of the housing 13. In particular, the surfaces 15 provide extra support for the particles when they are subjected to changing magnetic field strengths due to movement of the internal magnet assembly, and they also function to prevent backward motion of the magnetic particles (i.e. towards the first end of the apparatus).

The apparatus 10 also comprises a motor 16 which is operable to drive the internal magnet assembly.

The internal magnet assembly, shown in FIG. 10, is a series of magnetic units 17 linked together to form a chain, shown generally at 18. The chain 18 is driven back and forth within the housing 13 by the motor 16, in the direction shown by the arrows.

It will be appreciated that although the motor 16 is shown as being disposed directly on the second end 12 of the housing 13, it may in fact be positioned further away from the housing 13, provided that it is mechanically connected to the internal magnet assembly in order to drive it in the manner required. It will also be appreciated that although a motor is described, any other suitable means may be used to drive the internal magnet assembly in a reciprocating manner. For example, a hydraulic or a pneumatic piston cylinder arrangement could be used to translate reciprocating motion to the internal magnet assembly. Operation of the motor could be controlled manually or via a control unit. Operation could also be automated and/or controlled automatically in response to various parameters (for example, the flow rate of a fluid containing magnetic particles). The speed of the motor, and therefore the speed that the internal magnet assembly is reciprocated within the housing, can also be controlled.

FIG. 1D shows a section of the internal magnet assembly 18, including individual magnetic units and the linkages between them, in greater detail. The internal magnet assembly 18 includes a series of magnetic units 17, each comprising a permanent magnet 20 having an axial cylindrical hole through them (not shown). A pole piece 22 is affixed to the end of each magnet 20, to direct magnetic flux out of the housing, once assembled. Only one pole piece is provided at one side of each magnet 20 in order to manipulate the magnetic fields of the magnets in such a way as to prevent the magnets 20 from dragging collected magnetic particles retained on the outer housing back towards the first end of the apparatus when the magnet assembly is moved in use. Wear discs 24a, 24b are secured to the pole pieces 22 and the opposite side of the magnets 20, respectively. The wear discs 24a, 24b are resistant to abrasion and each have a greater diameter than that of the magnets 20 and the pole pieces 22, to protect them from wear during operation.

To link the magnetic units 17 together, each unit is provided with a male clevis 26 at one end having a hole 28, and a corresponding female clevis 30 at the other end, having a hole 32. Internally, a bolt or a stud is passed or slotted through the inner cylindrical hole of each magnet, and in each pole piece and each wear discs, to keep these parts together. At either end, the bolt or stud is also attached to, or passes through, each male and female clevis. Where a male clevis 30 of one magnetic unit 17 is positioned into the corresponding female clevis 26 of an adjacent magnetic unit, they are secured by a stud 34.

Adjacent magnets 20 within the assembly are arranged with repelling poles facing one another (i.e. in a N-N, S-S configuration). Because the magnets are repelling against one another, the magnetic fields which are produced by this configuration are wider reaching.

The apparatus can be used in various applications where magnetic separation is desired. For example, the first end of the apparatus could be immersed into fluid flowing through a ditch or a trough and containing magnetic particles, in order to remove these particles from the flow. Alternatively, the apparatus may be arranged to extend into a vessel or container, or through a bulkhead (or both). The apparatus can even be positioned to pass through a conduit. The apparatus can be adapted for use in specific applications and locations, and/or to conform to spatial constraints, by being provided with certain dimensions (length and diameter) and in a certain overall shape. It can be scaled up or down depending on the size of the magnetic particles to be separated in any specific application.

A particular advantage of the apparatus is that its use does not require permanent integration into a process and/or flow system; instead, the apparatus can simply be deployed when magnetic separation is required, with minimal disruption to the existing system and with little installation requirements. The apparatus can be permanently installed if desired.

A further benefit of the apparatus is that it does not comprise any external moving parts. External moving parts are generally undesirable because they are dangerous to personnel and the surrounding environment. In addition, they also tend to require extra maintenance, and there is the risk that such parts can become blocked or jammed during operation.

The apparatus does not require human intervention to operate because during use it can automatically and continuously collect and deposits magnetic material when the internal magnet assembly is running. As such, the apparatus can be considered as self-cleaning.

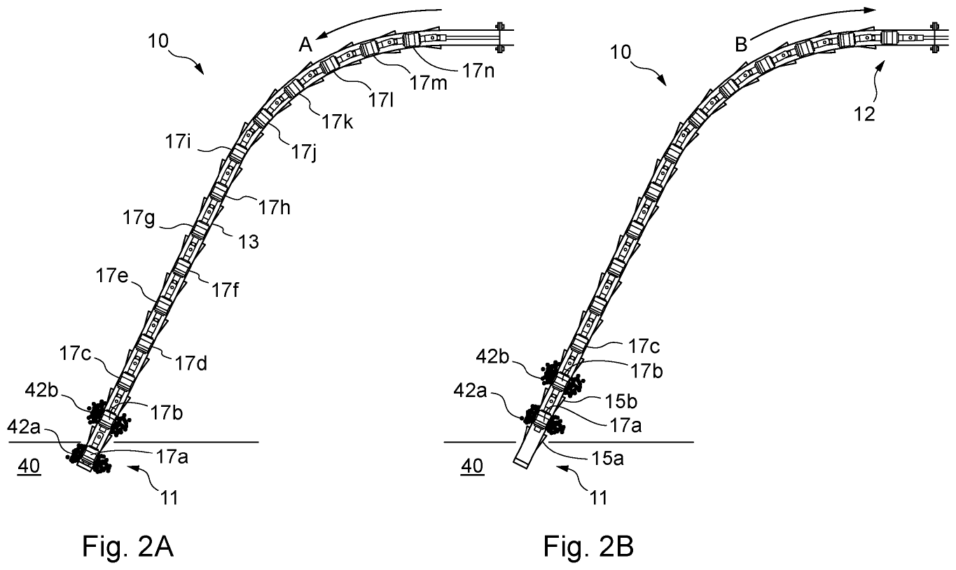

Operation of the apparatus will now be described with reference to FIGS. 2A to 2D.

Referring firstly to FIG. 2A, the first end 11 of the apparatus 10 extends into a volume of fluid 40 within a tank (not shown) which contains magnetic particles. The internal magnet assembly of the apparatus 10 comprises a series of magnets 17a to 17n, and the motor (not shown) is operable to drive the internal magnet assembly back and forth within the outer housing 13. In FIG. 2A, the motor has been operated to stroke the internal magnet assembly into a fully extended condition, in which the internal magnet assembly is shifted towards the first end 11 of the apparatus by a maximum distance. This movement of the internal magnetic assembly within the housing is indicated by the arrow A. The first two magnets 17a and 17b in the series of magnets in the assembly are positioned in the first end region of the outer housing, which partly extends into the fluid 40.

The magnetic field produced by the magnets 17a and 17b attract magnetic particles within the fluid to the outer surface of the outer housing 13 of the apparatus 10. The particles are shown arranged in annular clusters 42a, 42b, on the outer housing proximate the magnets 17a, 17b, respectively. For illustrative purposes, distinct clusters of magnetic particles are shown. However, it will be appreciated that the groups of magnetic particles attracted to more than one magnet may become joined and/or magnetic particles may exist on the surface of housing 13 in spaces adjacent a gap between magnets in the internal magnet arrangement.

With reference to FIG. 2B, the motor (not shown) has now been operated to stroke the internal magnet assembly into a fully retracted condition, in which the internal magnet assembly is shifted towards the second end 12 of the apparatus by a maximum distance. Movement of the internal magnetic assembly is indicated by the arrow B. Although the outer housing has not been moved and remains stationary within the fluid 40, the two magnets 17a and 17b are now located in the outer housing at a position above the fluid 40. Movement of the magnets 17a and 17b within the housing 13 has resulted in corresponding movement of the clusters of collected magnetic particles 42a and 42b along the outer surface of the housing 13 and over the ramped surfaces formed by the formations 14. In shifting towards the second end 12 of the apparatus, the first two magnets 17a and 17b are now positioned on alternate sides of the first two surfaces 15a and 15b on the outside of the housing.

The reciprocating motion of the internal magnet assembly continues and, as a result, magnetic particles which are attracted to the apparatus are moved along the entire length of the housing 13 until they are discarded by the apparatus at the second end 12. Subsequent motion of the magnets 17a . . . 17n towards the first end of the apparatus 11 will not move the collected magnetic particles back towards the first end because, as the magnets move, the next adjacent magnet in the series of magnets travels towards a cluster of collected particles to bring them under the influence of its magnetic field(s). In addition, the surfaces 15 formed by the conical ramped formations 14 along the length of the housing 13 impede backward motion of the particles. The surfaces 15 generally function to retain the collected particles at a location on the housing whilst the internal magnet assembly is in motion, to make sure that the particles move in one direction along the length of the housing 13 only: towards the second end 12.

The spacing between the magnets of the internal magnet assembly may be based on the spacing between the surfaces 15 on the outer housing 13. For example, spacing of the magnets may be selected such that with every stroke of the internal magnet assembly towards the second end 12 of the apparatus, each magnet is moved from a position before a surface (i.e. at the side of the surface closest to the first end of the apparatus), to a position after the surface (i.e. to the side of the surface closest to the second end of the apparatus), moving the collected particles to an equivalent location after the surface 15 on the outer surface of the housing.

As above, when the internal magnet assembly is moved back towards the first end of the apparatus (into the extended condition), each cluster of collected magnetic particles is brought under the influence of the magnetic field of the next adjacent magnet in the series. For example, when the internal magnet assembly moves back into the extended condition, after the retracted condition shown in FIG. 2B, the cluster 42a will be brought under the influence of the magnet 17b and the cluster 42b will be brought under the influence of the magnet 17c.

The reciprocating, back and forth movement of the internal magnet assembly, between the retracted and extended conditions, is repeated. This motion causes the magnetic particles to continue to move along the outer surface of the housing 13 towards the second end 12 of the apparatus. FIG. 2C shows the apparatus after multiple cycles of reciprocating motion of the internal magnet assembly have taken place. In FIG. 2C the internal magnet assembly has been moved in the direction indicated by arrow C into a fully retracted condition, shifted towards the second end 12 of the apparatus by a maximum amount. The clusters of collected magnetic particles 42a and 42b are now close to the second end 12 of the apparatus, but remain attracted to the outer housing 13 by magnets 17m and 17n, respectively.

Discharge of magnetic particles from the apparatus 10 is described with reference to FIG. 2D.

A portion of the internal magnet assembly near the second end of the apparatus, shown generally at 19, is intentionally left free of magnets. This portion 19 extends into the outer housing 13 when the internal magnet assembly is stroked towards the first end of the apparatus, into a fully extended condition.

Following FIG. 2C, the internal magnet assembly continues to operate, and is shifted towards the first end 11 of the apparatus into a fully extended condition, in the direction indicated by arrow D. As a consequence of this movement, the respective clusters of collected magnetic particles are brought under the influence of the magnetic field of the next magnets in the series. As such, the cluster 42a is now under the influence of the next magnet in the sequence, 17n. However, as the cluster 42b was previously under the influence of the last magnet in the sequence, magnet 17n (FIG. 2C), it is now no longer under the influence of any distinct magnet at all. The non-magnetic portion 19 now sits within the housing 13 at the previous location of cluster 42b.

In this position, after the final surface 15 at the second end of the apparatus, the magnetic field strength from the other magnets within the series is not strong enough to retain the magnetic particles on the outer surface of the housing 13. As such, the particles located and previously retained here (FIG. 2C) now fall away from the apparatus under the influence, as indicated by arrow E.

As the motion of the internal magnet assembly continues, discharging of collected particles also continues at the second end of the apparatus in the manner described. A container can be located underneath the second end of the apparatus to gather the discharged magnetic particles.

It will be appreciated that although only two discrete longitudinal groups of collected magnetic particles are shown in FIGS. 2A to 2D (for simplicity), there may be more and/or continuous clusters of particles along the length of the apparatus during operation. This will depend on, at least, the amount of magnetic particles within the fluid and/or whether the separation operation is required to be continuous (i.e. for a flowing fluid containing magnetic particles) or discrete (i.e. for an enclosed fluid within a container, containing a finite amount of metallic particles).

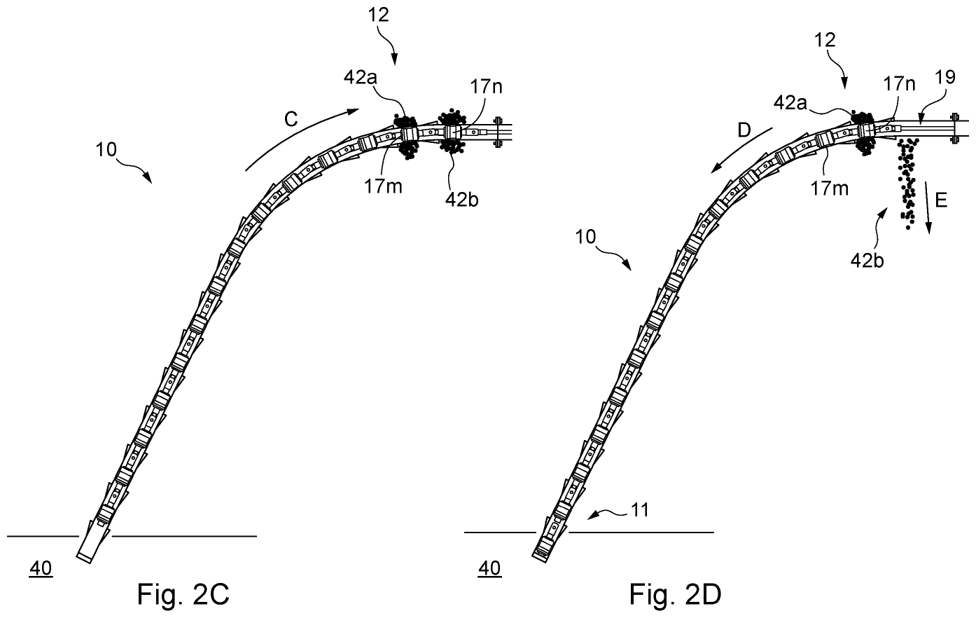

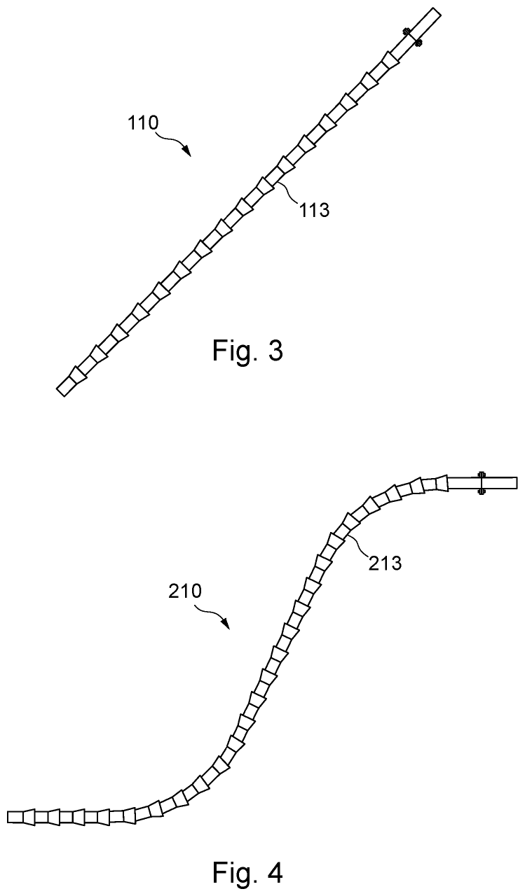

Apparatus with alternatively shaped outer housings are shown in FIGS. 3 and 4. The apparatus 110 of FIG. 3 has an outer housing 113 which is substantially straight. In operation, the apparatus may be inclined at an angle to the horizontal. The angle at which the apparatus is includes may depend on spatial operating constraints and the optimum angle for particle pick up and conveyance. The angle may also depend on the discharge requirements. For example, depending on the application, the apparatus may be inclined at an angle of approximately 45-degrees to the horizontal. The apparatus may also operate at an angle of 90-degrees to the horizontal.

Where the outer housing is straight or substantially straight, the internal magnet assembly may be configured differently because it is not required to navigate any curves or bends in the outer housing. As such, the internal magnet assembly may simply comprise a series of magnetic units mounted on a rigid (or flexible) rod.

The apparatus 210 of FIG. 4 has a generally S-shaped outer housing 213. The scale and shape of the apparatus, in combination with the expected scale of the magnetic particles that it will be used to collect, might be used to determine the number and the size of the internal magnets and of the formations provided on the outer surface of the housing.

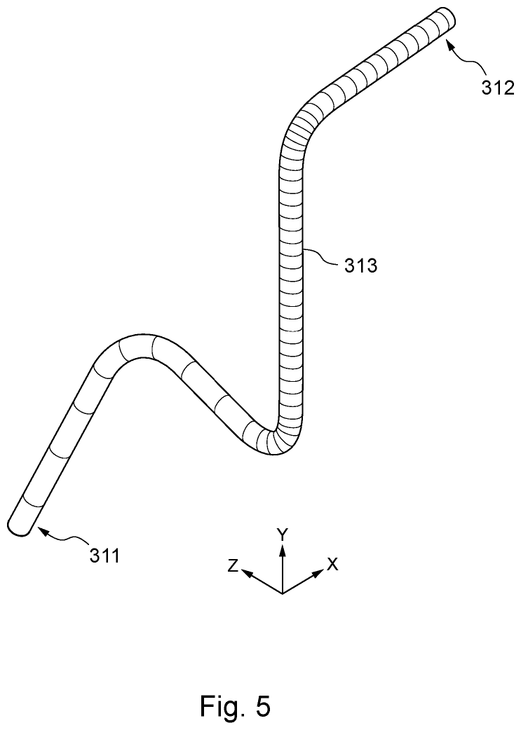

FIG. 5 is a schematic perspective view of another alternative configuration of the outer housing 313 of the apparatus 310. For simplicity, the formations on the housing are not shown. In use, the first end of the apparatus 311 would extend into a fluid containing magnetic particles for separation. The outer housing 313 of the apparatus is three-dimensionally oriented, having curves in more than one plane. The outer housing 313 curves upwardly and transversely away from the fluid (not show) to a discharge location at its second end 312, where the particles are discarded. Advantageously, the configuration of an outer housing can be designed based on the application and operating constraints (including spatial constraints) which it must satisfy. For example, where the apparatus is required to travel around a corner, around an object, or through an opening.

In addition, the internal magnet assembly can be provided with one or more centralisers to ensure that it remains substantially central within the outer housing and/or to assist with its motion within the outer housing. In particular, where the outer housing comprises numerous curves or bends (such as in the configuration of FIGS. 4 and 5) the provision of centralisers will help to prevent the internal magnet assembly from becoming jammed, and will protect the magnet assembly from experiencing excess wear. The centralisers can be provided with wheels or rollers for contacting the inner surface of the outer housing, to further assist with movement.

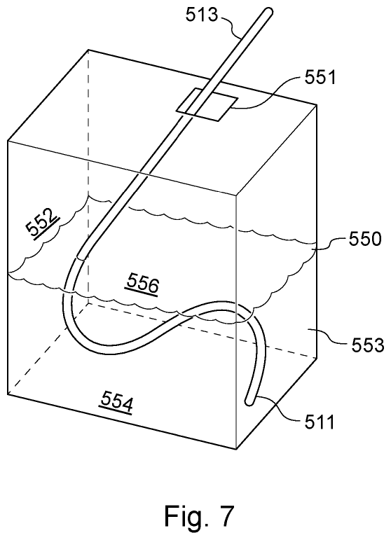

The outer housing of the apparatus may be formed as one rigid part, with a given length, diameter and shape. However, in an alternative embodiment of the invention, the outer housing is formed from various individual sections which, when assembled, form the outer housing. The sections can be rigidly attached to one another to form a housing that has a fixed shape, or attached to one another in such a manner as to form an articulated outer housing that can be manipulated into different configurations depending on the application, as described in greater detail below with reference to FIG. 7. Amongst other methods, the sections could be attached together by clamping, welding, screwing or curing. Any of the apparatus shown in the previous FIGS. 1A to 5B could be assembled in this way, from sections.

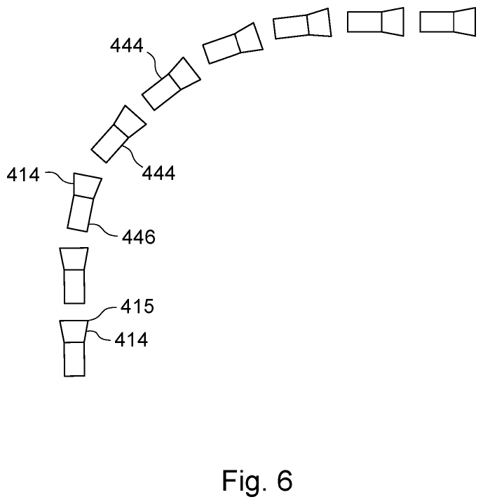

Various individual conduit sections 444 are shown in FIG. 6. Each section or part has a tubular potion 445 and a conical, ramped portion 414, expanding from the outer surface of the tubular portion 445. The inner diameter of each section is the same throughout; however, in alternative embodiments this could be varied. The sections can be secured together in any desired configuration. In the example shown in FIG. 6, the resulting apparatus will be substantially L-shaped (similar to that of FIG. 1A), with a substantially vertical portion configured for extending into the fluid for separation. Once assembled, the apparatus will function in substantially the same manner as described above.

For articulated assemblies, the sections might clip together or otherwise engage with one another to form a fluid tight connection whilst allowing adjacent sections to move with respect to one another. For example, articulated sections may each have a corresponding ball and socket, configured to connect to the socket or ball, respectively, of another section to form an articulated ball and socket joint. Other known alternative means of producing an articulated connection between conduit parts could be used. Any of the apparatus shown in the previous FIGS. 1A to 5 could be assembled in this way, from articulated sections.

Once secured to one another, for example by clipping in place, an articulated joint is formed between neighbouring sections. The joint may be self-sealing, for example if each of the sections are provided with seals and/or sealing arrangements within them, at the coupling locations. This type of flexible, articulated outer housing can be very useful in applications which require maximum flexibility, and/or which have very tight spatial constraints.

For example, an apparatus of this kind can be passed through a conduit to remove magnetic particles from inside. Due to the flexible nature of the outer housing, the apparatus will conform to the shape of the conduit as it passes through. In this application, the apparatus can be provided with outer centralisers to centralise it within the conduit and prevent it from becoming jammed or damaged on elbows or bends within the conduit, but which do not interrupt the functioning of the apparatus. Where an articulated apparatus is passed into a conduit for removal of magnetic particles from fluid contained therein, the resulting shape of the articulated apparatus will depend on the configuration of the conduit.

Another application in which a flexible, articulated outer housing is useful is for a tank or container having only a small access area. The outer housing of the apparatus can be fed into the tank, through a relatively small access hole. Whilst being fed through, the articulated housing will conform to the shape within the container. FIG. 7 schematically shows how an articulated housing 513 of the apparatus may change shape as it is fed into a tank 550. In this embodiment, the tank 550 contains a fluid having 553 having magnetic particles contained within it. Again, for simplicity, the formations are not shown and the shape of the housing is shown schematically as a single line.

The housing enters the tank 550 though a relatively small access hole 551. As the articulated housing impacts the inner surface of a side wall 552 of the tank, the housing 513 begins to curve. This happens again when the housing 513 comes into contact with the bottom surface 554 of the tank and the back surface 556. As such, a substantial length of the housing 513 is able to be located inside the tank, despite the small access hole 551, providing a greater amount of magnetic attraction to the fluid 553 to collect and remove the magnetic particles.

Once the articulated outer housing of an apparatus is moved into a given shape, in some applications it might be desirable to permanently fix this shape. This could be done by curing the sections together for example. For example, when the apparatus is moved into a particularly useful shape, which is perhaps expected to be useful for a long period of time or for multiple applications, it might be deemed worthwhile to simply fix the shape of the apparatus. This could also be done to prevent ingress into the housing where the sections are not self-sealing.

The invention provides an apparatus for separating ferrous particles from a liquid or slurry, and a method of use. The apparatus comprises an elongate housing, a magnet assembly located within the elongate housing and a drive means operable to translate reciprocating motion to the magnet assembly, to move it back and forth within the elongate housing. The elongate housing comprises one or more formations along its length.

Various modifications to the above-described embodiments may be made within the scope of the invention, and the invention extends to combinations of features other than those expressly claimed herein.

1. An apparatus for removing ferrous particles from a liquid or slurry, the apparatus comprising:
an elongate housing;
a magnet assembly located within the elongate housing;
a drive means operable to effect reciprocating motion to the magnet assembly such that the magnet assembly is reciprocated within the elongate housing; and
a plurality of formations along the length of the elongate housing,
wherein a first end or end region of the elongate housing is configured to be positioned to extend into a volume or body of the liquid or slurry; and
wherein the plurality of formations are configured to prevent the passage of at least some ferrous particles in one direction along the length of the elongate housing of the apparatus towards the first end of the apparatus during reciprocation of the magnet assembly.

2. The apparatus according to claim 1, wherein the magnet assembly is operable to attract and retain ferrous particles to an outer surface or surfaces of the elongate housing at the first end or end region and wherein the elongate housing comprises a second end or end region at which the magnet assembly is operable to discharge ferrous particles from the outer surface or surfaces of the elongate housing.

3. The apparatus according to claim 2, wherein the apparatus is operable to move the collected ferrous particles along and over the outer surface or surfaces of the elongate housing, from the first end or end region of the apparatus towards the second end or end region of the apparatus by operation of the magnet assembly.

4. The apparatus according to claim 1, wherein the plurality of formations each comprise a shoulder surface which projects outwardly from an outer surface of the housing.

5. (canceled)

6. (canceled)

7. (canceled)

8. The apparatus according to claim 1, wherein the elongate housing is formed from multiple conduit sections connected together to form an elongate housing in any desired size, shape and/or orientation

9. The apparatus according to claim 8, wherein each section comprises a housing portion and a formation portion such that, when assembled together, the sections form the elongate housing comprising a plurality of formations, wherein the plurality of formations are formed by the formation portions of the sections.

10. The apparatus according to claim 8 or 9, wherein the sections are connected to each other to form an articulated elongate housing wherein one or more section or sections is or are permitted to move with respect to its adjacent sections, and wherein the articulated elongate housing can be manipulated into a variety of shapes, and re-shaped when desired.

11. The apparatus according to claim 1, wherein the magnet assembly comprises one magnetic unit or a plurality of magnetic units and wherein each magnetic unit comprises at least one magnet.

12. The apparatus according to claim 11, wherein, where the magnet assembly comprises a plurality of magnetic units, they are arranged such that the at least one magnet of adjacent magnetic units have the same, repelling poles positioned adjacent to one another.

13. The apparatus according to claim 11, wherein the plurality of magnetic units are linked together to form a chain of magnetic units and wherein each magnetic unit is permitted to move with respect to its adjacent magnetic unit.

14. The apparatus according to claim 11, wherein the magnet assembly further comprises one or more sections which are devoid of magnetic units, and which are not configured to generate magnetic fields and wherein said sections are located where the apparatus is configured to discharge ferrous particles.

15. The apparatus according to claim 14, wherein the one or more sections devoid of magnetic units is located at the second end or end region of the apparatus.

16. The apparatus according to claim 1, wherein the apparatus further comprises one or more centralisers which are configured to be mounted to the magnet assembly and which function to retain the magnet assembly in a central positioned within the elongate housing during reciprocal motion.

17. A method of removing ferrous particles from a volume or a body of liquid and/or slurry, the method comprising:
providing an apparatus comprising:
an elongate housing comprising a plurality of formations along its length;
a magnet assembly located within the elongate housing; and
a drive means operable to effect reciprocating motion to the magnet assembly within the elongate housing;
wherein the plurality of formations are configured to prevent the passage of at least some ferrous particles in one direction along the length of the elongate housing of the apparatus towards a first end of the apparatus during reciprocation of the magnet assembly;
positioning the first end or end region of the elongate housing of the apparatus to extend into the volume or body the liquid and/or slurry;
attracting ferrous particles contained within the liquid or slurry to an outer surface or surfaces of the elongate housing under influence of the magnet assembly;
operating the drive means to reciprocate the magnet assembly within the elongate housing; and
moving the ferrous particles along the outer surface or surfaces of the elongate housing under influence of the reciprocating magnet assembly.

18. The method according to claim 17, wherein the magnet assembly is operable to attract and retain ferrous particles at the first end or end region of the elongate housing, wherein the elongate housing comprises a second end and/or end region at which the magnet assembly is operable to discharge ferrous particles, and wherein the method comprises attracting and collecting ferrous particles from the liquid or slurry at the first end or end region of the elongate housing and discharging ferrous particles at the second end or end region of the elongate housing.

19. The method according to claim 18, wherein the magnet assembly has a first fully extended condition in which it is moved towards the first end or end region of the elongate housing by a maximum distance, and a second, fully retracted condition in which it is moved towards the second end or end region of the elongate housing by a maximum distance, and wherein the method comprises operating the drive means to move the magnet assembly between its first, fully extended, condition and its second, fully retracted, condition, and vice versa.

20. The method according to claim 19, comprising attracting ferrous particles contained within the volume or body of liquid and/or slurry to the outer surface of the first end or end region of the elongate housing when the magnet assembly is in its first, fully extended condition.

21. The method according to claim 19, comprising operating the drive means to reciprocate the magnet assembly back and forth between the first, fully extended, condition and the second, fully retracted, condition, causing ferrous particles attracted to the first end or end region of the apparatus to move along the length of the outer surface or surfaces of the elongate housing towards the second end or end region of the apparatus.

22. (canceled)

23. The method according to claim 19, comprising exposing the collected ferrous particles to a region of low, minimal or no magnetic field strength and releasing and discharging ferrous particles from the apparatus when they are no longer attracted to the apparatus by a magnetic field.

24. An installation on an oil and gas drilling facility, the installation comprising:
a shale shaker configured to receive fluids from a drilling operation, the shale shaker comprising a header box; and
a magnetic separator apparatus comprising;
an elongate housing comprising a first end, and second end and a plurality of formations along its length;
a magnet assembly located within the elongate housing; and
a drive means operable to effect reciprocating motion to the magnet assembly such that magnet assembly reciprocates within the elongate housing;
wherein the plurality of formations are configured to prevent the passage of at least some ferrous particles in one direction along the length of the elongate housing of the apparatus towards the first end of the apparatus during reciprocation of the magnet assembly;
wherein the first end or end region of the elongate housing of the magnetic separator apparatus extends into the shale shaker header box and is at least partially immersed in the fluids therein when in use.
